(19) United States
(12) Patent Application Publication
(10) Pub. No.: US 2025/0182453 A1
(43) Pub. Date: Jun. 5, 2025

(54) GENERATING COMPRESSED REPRESENTATIONS OF VIDEO FOR EFFICIENT LEARNING OF VIDEO TASKS

(71) Applicant: DeepMind Technologies Limited, London (GB)

(72) Inventors: Olivia Anne Wiles, London (GB); Mateusz Malinowski, London (GB); Andrew Zisserman, London (GB); Iain Barr, Cambridge (GB); Joao Carreira, St. Albans (GB)

(21) Appl. No.: 18/844,744

(22) PCT Filed: Mar. 7, 2023
(86) PCT No.: PCT/EP2023/055757

§ 371 Date: Sep. 6, 2024

Related U.S. Application Data
(60) Provisional application No. 63/317,459, filed on Mar. 7, 2022.

(51) Int. Cl. G06V 10/774; G06V 10/74; G06V 10/82; G06V 20/40

(52) U.S. Cl. CPC G06V 10/774; G06V 10/761; G06V 10/82; G06V 20/41

(57) ABSTRACT

A method is proposed to train an adaptive system to perform a video processing task, based on a database of compressed representations of video data items. The compressed representations were generated by a trained adaptive compressor unit.

### CROSS-REFERENCE TO RELATED APPLICATION

This application claims priority to U.S. Provisional Application No. 63/317,459, filed on Mar. 7, 2022. The disclosure of the prior application is considered part of and is incorporated by reference in the disclosure of this application.

### BACKGROUND

This specification relates to methods and systems for training an adaptive system to perform a video processing task. One common form of adaptive system is a neural network.

Neural networks are machine learning models that employ one or more layers of nonlinear units to predict an output for a received input. Some neural networks include one or more hidden layers in addition to an output layer. The output of each hidden layer but the last is used as input to the next layer in the network, i.e., the next hidden layer or the output layer. Each layer of the network generates an output from a received input in accordance with current values of a respective set of parameters.

One common use for neural networks is to perform video processing tasks, commonly called “computer vision”. Most computer vision research focuses on short time scales of two to ten seconds at 25 fps (frames-per-second) because vision pipelines do not scale well beyond that point. Raw videos are enormous and must be stored compressed on a disk; after loading them from a disk, they are decompressed and placed in a device memory before using them as inputs to neural networks. In this setting, and with current hardware, training models on minute-long raw videos can take prohibitively long or take too much physical memory. Even loading such videos onto GPU or TPU might become infeasible, as it requires decompressing and transferring them, often over bandwidth-limited network infrastructure.

### SUMMARY

This specification generally describes how a system implemented as computer programs in one or more computers in one or more locations can perform a method to train (that is, iteratively adjust parameters of) an adaptive system to perform a video processing task, such as recognizing the content of a compressed representation of a video data item (i.e. the data defining a video) made up of a sequence (plurality) of image frames. Each image frame is a dataset including one or more respective pixel values (e.g. three pixel values respectively defining RBG intensities) for each of a two-dimensional array of pixels.

In general terms, the disclosure proposes that compressed representations of video data items are generated by another adaptive system (a “compressor unit”) which has been trained to do so. Using the trained compressor unit, a first database of video data items may be used to generate a second database of compressed video data items, which may be used as training data for training the adaptive system to perform the video processing task. The video data items in the first database may be simulated videos, i.e. generated by a computer from a simulated environment. Alternatively or additionally, they may comprise, or consist of, videos captured in one or more real-world environments by one or more video cameras.

The videos in the first database are typically not used during the training of the adaptive system, i.e. only the compressed representations of the video data items in the first database are used. The compressed representations may be far smaller (as measured in bits) than the corresponding video data items (e.g. at least a factor of 10 smaller, and optionally much more). This dramatically reduces the computational effort required to train the adaptive system, compared to using the video data items in the first database directly. Furthermore, the video data items of the first database may be discarded (e.g. deleted) prior to the training of the adaptive system, e.g. once their corresponding compressed representations are generated, so that the required data storage is much reduced.

Training the adaptive system based on compressed video items makes it possible to train the adaptive system more quickly, and to process much longer videos. For example, it makes it possible to process video data items corresponding to time periods (e.g. periods in which the video data items were captured) lasting more than a few seconds, such as videos lasting one or more minutes, at least an hour, or multiple hours or even days. This makes it possible to perform video processing tasks which are based on features which extend over such periods, e.g. performing reasoning based on features of the video which are spaced apart by minutes, hours or days.

The compressor unit may be obtained from a source (e.g. over a communications network), or be obtained by training it as part of a compressor-reconstruction system which further includes an adaptive “reconstruction network” to reconstruct video data items from their compressed representations generated by the compressor unit. In other words, the compressor unit may be considered as the “encoder” of an auto-encoder, and the reconstruction network may be considered the “decoder” of the auto-encoder.

The compressor unit may include at least one three-dimensional convolution unit. For example, the compressor unit may include a stack (sequence) of one or more convolution units, such that a first of the convolution unit receives data input, and, in the case that there more than one convolution unit, each convolution unit except the first receives the output of a preceding one of the convolution units. At each of successive times, the first convolution unit receives a corresponding plurality of the image frames of the video data item (i.e. a proper subset of the image frames). Each convolution unit performs a convolution on the data it receives. Thus, the first convolution unit performs a convolution on a received plurality of image frames using a kernel which performs a function of pixel values relating to pixels in different ones of the image frames (a temporal dimension) and pixels in different rows and columns of each of those image frames (two spatial dimensions). The parameters of the compressor unit which are adjusted during the training procedure may include one or more parameters defining the kernel. The (or each) convolution network may apply the kernel with a stride of 1 for all three dimensions, or a stride different from one in at least one of the three dimensions, e.g. the same stride different from 1 in both the spatial directions.

In one case, the compressed representation of each video data item may comprise a number of elements (“compressed image frames”) which has a one-to-one mapping with the image frames of the video data item. That is, each compressed image frame corresponds to a respective one of the image frames. Each of the compressed image frames may generated by the compressor unit based on the output of the convolution unit(s) when the first convolution unit receives a subset of the image frames of the video data item including the corresponding image frame, e.g. a clip of the video defined by the video data item (i.e. a plurality of consecutive image frames in the video data item which is a (proper) subset of the image frames of the video data item). The clip may for example be centred on the corresponding image frame, i.e. the number of image frame(s) in the subset which are later in the video data item than the corresponding image frame is substantially equal to the number of image frame(s) in the subset which are earlier in the video data item than the corresponding image frame. For example, the clip may be composed of 32 consecutive image frames of the video data item, with the corresponding image frame as the 16^{th} or 17^{th} of these image frames.

In another case, the number of compressed image frames may be less than the number of image frames in each video data item. For example, the image frames may be partitioned into a number of subsets of consecutive frames (possibly overlapping subsets) which is less than the number of image frames, and each compressed image frame may be generated from the corresponding subset of image frames.

A portion of the compressor unit (e.g. the input portion of the compressor unit) may be designated an “encoder network”). The encoder network may, for example, include the convolution unit, or stack (sequence) of convolution units. The encoder network may include one or more further layers which collectively process the output of the convolution unit(s). For example, the encoder network may include at least one ResNet (residual neural network) layer, and/or at least one inverted ResNet layer (see “MobileNetV2: Inverted Residuals and Linear Bottlenecks”, Sandler M. et al, arXiv:1801.04381v41. It may furthermore include at least one recurrent layer, such as a LSTM (long short-term memory). At each of plural successive times (time steps) the encoder unit may process respective subsets of the image frames to generate an output, e.g. a subset including an image frame which corresponds under the mapping to a compressed image frame which is generated by the compressor unit, based on the output of the encoder at that time. Note that in some embodiments, later layers of the encoder are working on data derived from one subset of the image frames of the video data item while earlier layers are working on data derived from the next subset of the image frames of the video data item.

The number of image frames in a video data item may be denoted I_{T}, and the number of subsets of image frames (i.e. the number of encoder outputs which the encoder network generates from the video data item) may be denoted T_{T}. Each subset of the image frames, used to generate a corresponding encoder output, may be a sequence of consecutive image frames from the video data item. If the subsets of image frames used to generate different encoder items are non-overlapping, then the number of image frames in each subset may be I_{T}/T_{T}, but alternatively the subsets of image frames may be overlapping (e.g. each subset of image frames except the first may overlap with a preceding subset of the image frames). Furthermore, in principle each subset of the image frames may not be composed of consecutive image frames in the video data item. For example, considering image frames of the video data items as being numbered from 1 to I_{T}, a first subset of the image frames may be image frames 1, 3 and 5; a second subset could be image frames 2, 4 and 6; a third subset of the image frames may be image frames 3, 5 and 7, and so on up to a final subset I_{T-4}, I_{T-2}, I_{T}. In this example Tₜ=I_{T}−2, but in other examples T_{T} may be much less than I_{T} such as no more than I_{T}/2.

The output (“encoder output”) of the encoder network generated from a given subset of the image frames (“encoder input”) may be considered as an array (or sequence) of latent variables (each of which may itself have one or more components). The compressed image frame may be generated by an output stage of the compressor unit from the array of latent values using at least one “codebook” (database). The “codebook” comprises vectors referred to as “latent embedding vectors”. Each of the latent embedding vectors in the codebook(s) is associated with a respective index value, the index values for different latent embedding vectors of a given codebook being different so that each index value uniquely identifies one of the latent embedding vectors. Each latent embedding vector may have the same number of components, which may the same number of components as each of the latent variables. The latent embedding vectors may be predefined, or some or all of the latent embedding vectors may be defined by parameters which are trained during the training of the compressor unit.

For each latent variable of the encoding vector, an output stage of the compressor unit may identify, for one or more of the codebooks (e.g. all the codebook(s), or if there are multiple codebooks, a selected one of the codebooks, e.g. selected based on the encoder output; not that in this case the compressed representation may include an indication of which codebook was selected), the nearest one of the latent embedding vectors in the codebook to the latent variable (based on a distance measure between latent variables and latent embedding vectors, e.g. Euclidean distance or Manhattan distance), and generate a corresponding portion of the compressed representation according to the determined nearest latent embedding vector. For example, the corresponding portion of the compressed representation may encode the latent variable as the index value of that nearest latent embedding vector. Thus, the compressed image frame generated by the compressor unit from a given subset of the image frames of the video data item may comprise (or consist of) the respective index value of the respective latent embedding vector (of each of one or more of the codebook(s)) which is nearest to each of the respective latent variables of the encoder output which is generated by the encoder based on the subset of image frames.

The compressor unit and the reconstruction network may be iteratively trained jointly (i.e. by updates to the compressor unit being interleaved with updates to the reconstruction network, or by repeated synchronous updates to both the compressor unit and reconstruction network). The training may be performed using a training set of video data items. The training may be performed using a loss function which is indicative of discrepancy, summed over the training set of video data items, between each video data item and a reconstruction of the video data item generated by the reconstruction network. For example, for each of the training set of video data items, the discrepancy may be a sum over the image frames of the video data item of a distance (e.g. a Euclidean distance) between reconstructed image frames generated by the reconstruction network based on the respective compressed image frames which the compressor unit generated from the video data item. Once the compressor unit has been trained it may be used to generate compressed representations of received video data item(s). This method of generating compressed representations of received video data item(s) constitutes an independent aspect of the present disclosure. In principle, the compressed video representations may be used for other purposes than for training adaptive systems, e.g. they may be decompressed and watched.

The training set of videos may be simulated videos. Alternatively or additionally, they may comprise, or consist of, videos captured in one or more real-world environments by a video camera. The training set may optionally include one or more of the video data items in the first database (i.e. the compressor unit and reconstruction unit may optionally, but need not be, trained using video data items which are used later to teach the adaptive system to perform the video processing task).

The reconstruction network may optionally comprise an input stage which uses the codebook(s) of latent embedding vectors to reconstruct the encoder output of the encoder network from the compressed representation it receives. The reconstruction network may apply the reconstructed encoder output, or in the case that the input stage is omitted, the compressed representation itself, to a decoder network, which like the encoder network may comprise a stack of one or more neural layers defined by parameters which are varied during the training procedure. Each of the layers but the first (which receives the reconstructed encoder output), receives the output of the preceding layer of the stack. The stack of layers may include at least one convolution layer (which typically performs a two-dimensional convolution in just spatial dimensions), at least one ResNET or inverted ResNET layer, and/or at least one recurrent layer such as an LSTM layer.

The adaptive system which is trained based on the compressed representations in the second database, may likewise optionally comprise an input stage which, upon receiving a compressed representation of a video data item (e.g. one compressed image frame at a time), uses the codebook(s) of latent embedding vectors to reconstruct the encoder output of the encoder network which generated the compressed video item. The adaptive system may further comprise a stack (sequence) of layers, of which the first layer receives sequentially the reconstructed encoder outputs, or in the case that the input stage is omitted, the compressed representation itself (e.g. as a sequence of compressed image frames corresponding to respective subsets of image frames of the video data item; in this case, the adaptive system typically receives the compressed image frames in successive time-steps, according to the sequence of the corresponding subsets of image frames in the video data item). The stack of layers may include at least one convolution layer (which typically performs a two-dimensional convolution in just spatial dimensions), at least one ResNET or inverted ResNET layer, and/or at least one recurrent layer such as an LSTM layer. Generally, the adaptive system may have the overall structure of any conventionally known neural network used for processing video, differing only in that its input layers may be much smaller, e.g. to match the size of compressed image frames rather than image frames as in conventional systems. Similarly, the algorithm which is used to train the adaptive system based on the compressed representations in the second database, may be similar to any known algorithm which is conventionally used to train an adaptive system to perform a video processing task. It is advantageous that the present technique can employ known neural network architectures and/or training algorithms in this way. Some examples are given below, in the context of specific classes of video processing task.

Many known algorithms used to train adaptive systems to perform video processing tasks make use of training data “augmentation”. This refers to a process in which training data in the form of video data items is modified to generate additional training data items. An advantage of doing this is to avoid over-fitting of the training data. Particularly in embodiments in which the video data items of the first database are no longer available when the step of training the adaptive system is carried out (e.g. because the first database has already been discarded, e.g. deleted or overwritten, to reduce memory requirements), it would be valuable to be able to perform training data augmentation based on the compressed data items.

For that purpose, the method may comprises training an adaptive augmentation network to receive compressed representations generated by the compressor unit based on corresponding video data items (e.g. compressed data items from the second database), and from the compressed representations generate respective modified compressed representations. The modified compressed representation generated from a given compressed representation is an estimate of the compressed representation which would have been obtained if the video data item from which the given compressed representation was obtained, had been subject to a modification operation, and then compressed by the compressor unit. Below, as a shorthand, the operation performed by the augmentation network is referred to as applying a modification operation to a compressed representation, but this is to be understood in the present sense: for example, applying a (spatial) cropping operation to a given compressed representation does not mean that the given compressed representation is itself cropped, but rather generating a compressed representation of a video data item which is a cropped form of the video data item from which the compressor unit generated the given compressed representation.

For each of one or more of the compressed representations in the second database, the augmentation network is used to generate one or more corresponding modified compressed representations for different respective modification operations. The modified compressed representations are added to the second database. The subsequent training of the adaptive system to perform the video processing task uses the modified compressed representations in addition to (or in principle, instead of) the compressed representations stored in the second database. Note that the modified compressed representations can be generated at a time when the first database has been discarded (e.g. deleted or made available for overwriting), so there is no need to store the video data items in first database until modified compressed representations are required for augmentation.

The augmentation network may be implemented by a neural network of any structure, e.g. one comprising a multi-layer perceptron (MLP) and/or a transformer (see “An Image is Worth 16×16 Words: Transformers for Image Recognition at Scale”, by A. Dosovitskiy et al, arXiv:2010.11929v2). Like the reconstruction network and adaptive system, the augmentation network may optionally include an input stage for decoding the compressed representation using the codebook(s).

In principle, it would be possible to generate multiple augmentation networks for applying respective modifications to a compressed representation of a video data item. More conveniently, however, a single augmentation network may receive an input (“modification data”) which specifies a modification operation the augmentation network should apply to a compressed representation which is also received by the augmentation network. Thus, conveniently, for each of the one or more of the compressed representations in the second database, the augmentation network may generate a plurality of corresponding modified compressed representations successively, by successively receiving the compressed representation multiple times, and at each of those times receiving different modification data.

The training of the adaptive augmentation network may be based on a reconstruction loss function comprising a discrepancy term indicative of a discrepancy (as measured by a distance measure, such as Euclidean distance), for each of a plurality of compressed representations, between an output of the reconstruction network upon receiving the corresponding modified compressed representation and a modified video data item which is obtained by performing a modification operation to the corresponding video data item. In the case that the augmentation network is trained to perform a selected modification operation according to modification data it receives, the discrepancy term may be summed over a plurality of possible realizations of the modification data. That is, the discrepancy term is indicative of a discrepancy, for each of a plurality of compressed representations and each of a plurality of possible realizations of the modification data, between an output of the reconstruction network upon receiving the corresponding modified compressed representation and a modified video data item which is obtained by performing the modification operation to the corresponding video data item specified by the realization of the modification data.

Suitable modification operations may comprise any one or more of a crop operation (the modification data may specify which area(s) of which input frames are cropped, e.g. the same area for each input frame of the video data item); a brightness modification (the modification data may specify what the brightness modification is, and optionally in which area(s) of which input frames it is applied); a clipping operation (the modification data may specify a clipping range, such that all the pixel values of the input frames of the video data item are clipped to be in the clipping range (that is, if they are outside the clipping range, modified to be at the closest end of the clipping range)); a rotation operation (the modification data may specify by what angle); a blurring operation (the modification data may specify how much blurring is applied, and optionally in which area(s) of which input frame(s)); a flipping operation (in which upward/downward or left-right directions are reversed); and a color modification (the modification data may specify which color(s) are modified, and optionally in which area(s) of which image frames).

Optionally, the modification operation may be selected by an adaptive unit which is trained jointly with the augmentation network to generate a modification operation which maximizes the discrepancy term. Specifically, the modification data may specify an adversarial perturbation i.e. a perturbation which is selected to increase a likelihood that the augmentation network generates a modified compressed representation with a high value for the discrepancy term. For example an adversarial attack may be implemented using the technique described in Madry et al., arXiv: 1706.06083, e.g. to maximize the discrepancy term.

### BRIEF DESCRIPTION OF THE DRAWINGS

FIG. 1 shows a compressor-reconstruction system for joint training of an encoder network of a compressor unit and a decoder network of a reconstruction network.

FIG. 2 shows the use of a compressor unit to populate a database of compressed representations of video data items.

FIG. 3 shows the use of a database of compressed representations of video data items to train one or more adaptive systems to perform corresponding video processing tasks.

FIG. 4 shows the training of an augmentation network to generation modified compressed representations.

FIG. 5 shows the usage of a trained adaptive system to perform a corresponding video processing task.

FIG. 6 is a flow diagram of an example method for compressing a first video data item.

FIG. 7 is a flow diagram of an example method for training an adaptive system to perform a video processing task.

Like reference numbers and designations in the various drawings indicate like elements.

### DETAILED DESCRIPTION

This specification describes an adaptive model training system implemented as computer programs on one or more computers in one or more locations.

The adaptive model training system employs a compressor unit configured to receive video data items which are each a sequence of image frames, and from them generate corresponding compressed representations of the video data items. Each image frame is an I_{H} by I_{L} array of pixels (where I_{H} and I_{L} are integers, e.g. each at least 10), with one or more intensity values for each pixel. For example, there may be three values (e.g. red-green-blue (RGB) values) for each pixel.

FIG. 1 shows a compressor-reconstruction system for training a compressor unit 11 jointly with a reconstruction network 12. The compressor unit 11 comprises an encoder network 111 configured to receive, at each of successive time, a corresponding encoder input which is (or which is derived from) a corresponding subset of image frames of a video data item 13. In principle, each subset of image frames could be just a single image frame, but it may be a plurality of image frames of the video data item. From each encoder input, the encoder network 111 generates a corresponding encoder output in the form of a spatial tensor, such as a two-dimensional tensor. For example, for each given i-th subset of image frames of the video data item (where i is an integer variable labelling subsets of image frames of the video data item), the encoder network 111 receives at successive times, for successive corresponding values of i, a corresponding i-th encoder input which comprises the given subset of the image frames. The subset of image frames may include a “central” image frame and one or more further images frames which are earlier and/or later than the “central” image frame in the video data item; for example, the J immediately preceding image frames in the video data item and the L immediately succeeding image frames in the video data item, where J and L are integers. The compressor unit 11 further includes an output stage 112 which receives each successive encoder output, and from it generates a corresponding output comprising a plurality of “index values” (codes).

Since the encoder input includes a plurality of image frames (when there are multiple image frames in each subset of the image frames of the video data item), the encoder network 111 applies a 3D convolution to the encoder input. The encoder network 111 typically includes at least one convolutional unit (convolutional layer) which applies a 3D convolution, and may optionally include further layers, such as ResNet layer(s) and/or inverted ResNet layer(s).

As mentioned, the encoder output of the encoder network 111, upon receiving a given encoder input, is a spatial tensor, which comprises a plurality of vectors (e.g. a 2-D array in which every element of the array is a vector). Each vector may be considered as a multi-component latent variable.

Upon receiving an encoder output, the output stage 112 is configured to compare each of the vectors (latent variables) of the encoder output with a one or more “codebooks”, each comprising a corresponding plurality of vectors referred to as “latent embedding vectors”. Each latent embedding vector may have the same number of components, and this may be the same number of components as each of the vectors (latent variables). Each of the codebooks further comprises, for each of its latent embedding vectors, an associated respective index value, the index values for different latent embedding vectors being different so that each index value uniquely identifies one of the latent embedding vectors. Collectively the latent embedding vectors, and their associated index values, form the codebook.

Optionally, there may be multiple codebooks. That is, the number of codebooks is denoted by Tc which may be greater than one. For simplicity in the discussion below, the number of codebooks will sometimes be assumed to be 1, but the operation of the encoder network 111, and the corresponding input stages 122 and 312 described below which make use of the same codebooks, should be understood as embracing the possibility of Tc being greater than 1.

The output stage 112 is configured to determine, for each vector of the encoder output, the latent embedding vector (of each codebook) which is closest to that vector of the encoder output according to a distance measure (e.g. Euclidean distance or Manhattan distance), and to output the associated index value. Thus, the output stage 112 converts the encoder output to a compressed image frame formed of a plurality of index values, i.e. to a number of index values which is equal to the number of vectors (latent values) in the encoder output times the number of codebooks. The sets of index values successively outputted by the output stage 112 upon successively receiving the encoder outputs for the successive corresponding subsets of image frames of a video data item, constitute a compressed representation of the video data item.

In summary, the compressor unit 11 is defined by a plurality of variable numerical parameters which are trained during the training of the encoder network 111. These comprise numerical parameters which define the encoder network 111, and numerical parameters which define the latent embedding vectors of the at least one “codebook” used by the output stage 112. The compressor unit 11 applies two forms of compression: a first compression performed by the encoder network 111 which reduces a given subset of the image frames to a reduced data size (e.g. a two-dimensional array of latent values), and a second form of compression which reduces the latent values to index values, where each index value is defined by fewer bits than the corresponding latent value.

Each compressed representation has a lower data size than the corresponding video data item (e.g. at least 20 times smaller). Specifically, if the video data item has I_{T} images, which are each RGB values, which may take any integer in the range 0 to 255, for each of a I_{H}×I_{L} array of pixels, then the video data item has a data size of I_{T}I_{H}I_{L}*3*log₂ 256, and the compressed representation has a data size T_{T}T_{H}T_{L}T_{C} log₂ K, where T_{T} is the number of encoder outputs generated when the encoder network processes the video data item (i.e. the number of subsets of image frames for a given video data item), and the encoder output is a tensor which is a 2-D array containing T_{H}×T_{L} vectors, each of the same size as the latent embedding vectors of the codebook(s), and there are K latent embedding vectors in each of the Tc codebooks. Thus, the compression ratio is cᵣ=I_{T}I_{H}I_{L}*3*log₂ 256/T_{T}T_{H}T_{L}T_{C} log₂ K.

The reconstruction network 12 comprises an input stage 122 which is configured, for each subset of image frames of a video data item, to convert the corresponding set of index values in the compressed representation of the video data item 13 (i.e. the corresponding compressed image frame), to the corresponding latent embedding vectors. In other words, the output of the input stage 122, for a given compressed image frame, is a plurality of the latent embedding vectors. Each of these latent embedding vectors approximates a corresponding vector of the corresponding encoder output. Thus, the output of the input stage 122 is an approximate reconstruction of the corresponding encoder output.

The set of latent embedding vectors for the given subset of image frames of the video data item is input to a decoder network 123. That is, it forms a decoder input of the decoder network 123. Like the encoder network 111, the decoder network 123 may comprise a stack of one or more neural layers. Each of the neural layers but the first (which receives the reconstructed encoder output), receives the output of the preceding layer of the stack. The stack of layers may include at least one convolution layer (which typically performs a two-dimensional convolution in just spatial dimensions), at least one ResNET or inverted ResNET layer, and/or at least one recurrent layer such as an LSTM layer.

The output of the decoder network 123, upon receiving a given decoder input, is a set of reconstructed image frames corresponding to a given subset of image frames of the video data item 13. All the reconstructed image frames for a given compressed representation of a video data item 13 together form a reconstructed video data item 14.

The compressor unit 11 and reconstruction network 12 are trained jointly, using a plurality of video data items 13, to minimize a measure of a discrepancy between the video data items 13 and the corresponding reconstructed video data items 14. During this process, the numerical parameters defining the encoder network 111, the numerical parameters defining the decoder network 123, and optionally also the latent embedding vectors defining the codebook employed by the output stage 112 and the input stage 122, are iteratively trained.

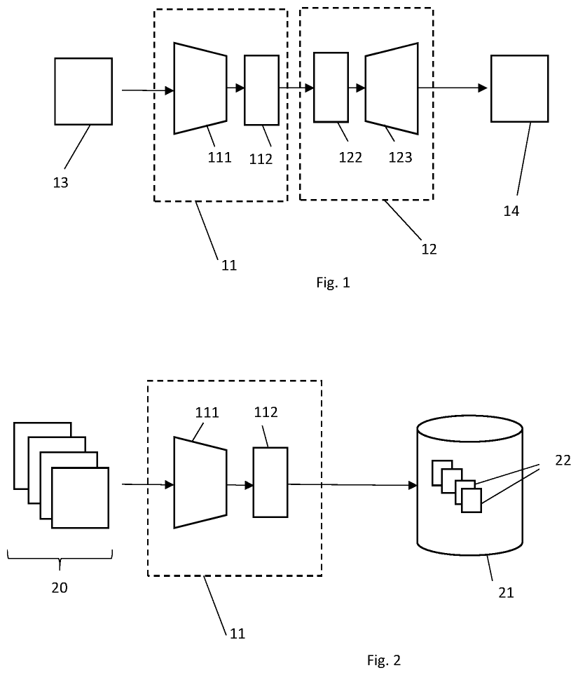

Once the compressor unit 11 has been obtained in this way, it is used as shown in FIG. 2. Specifically, the compressor unit 11 is used to compress a first database 20 of videos, to generate a second database 21 of corresponding compressed representations 22. The compressed representations 22 are stored, e.g. on a disk or other data carriers. Once this is done, there is no need for the videos in the first database 20 to be stored, and they can be deleted to free-up space. The second database 21 is far smaller (e.g. at least 20 times smaller, when measured by the number of bytes of data it employs) than the first database 20, and thus can be stored with much reduced computational cost.

Any given video in the first database 20 may be associated with corresponding labels. The label may indicate the content of the video, or indicate the content of one or more specific portions of the first video. The portion(s) may be defined spatially (i.e. as a portion of the image frames of the video) and/or temporally (i.e. as a proper subset of the frames of the video). Thus, for example, a label “cat” may be associated with a video data item which shows a cat in some or all (e.g. at least a certain proportion) of the image frames (e.g. all the image frames); or with those image frame(s) which show a cat; or with those spatial areas within the image frame(s) which show a cat. In this case the labels may be included in the second database 21 (in the same format as in the first database 20, or a different (e.g. compressed) format), associated with the corresponding compressed representations 22. Thus, following the deletion of the video data items of the first database 20, the only storage requirement may be for the compressed representations of the video data items, the associated labels and data defining the compressor unit 11 such as the codebook(s) (e.g. the latent embedding vectors for each of the codebooks).

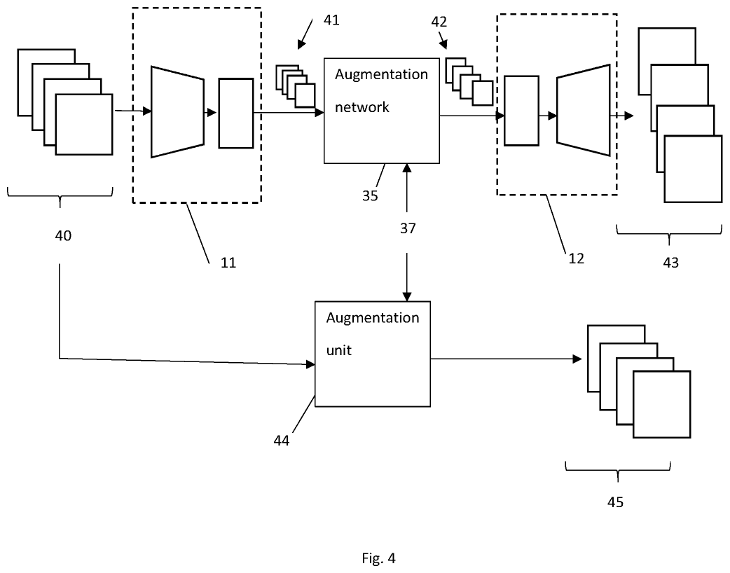

Before the video data items in the first database 20 are deleted, it is possible to augment the second database 21 by forming modified versions of the video data items, and compressing them using the compressor unit 11 as compressed representations of the modified videos. For example, the augmentations may include one of more of a brightness modification, a clipping operation, a rotation operation, a blurring operation, a flipping operation and/or a color modification. The brightness modification, blurring operation and color modification may optionally be applied to a selected portion of the image frames of a given video data item. Once the first database 20 is deleted, however, generating modified video data items is less straightforward, but below an augmentation network is described with reference to FIG. 4 which makes it possible to augment the second database 21 even when the first database 20 has been deleted or is otherwise longer accessible.

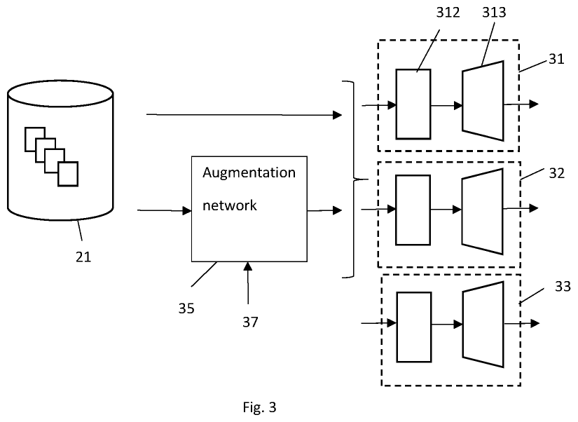

Turning to FIG. 3, a way of employing the second database 21 is described. The compressed representations are used to train one or more adaptive systems 31, 32, 33 to perform corresponding video processing tasks. Examples of these tasks are given below, but they may include frame prediction, reconstruction, classification, etc.

Each of the adaptive systems 31, 32, 33 includes an input stage (e.g. input state 312) which decodes the compressed representation, by extracting for each index value of the compressed representation, determining the corresponding latent embedding vector of the codebook, and outputting those latent embedding vectors.

As noted above, an encoder output of the encoder network 111 corresponds to a given subset of image frames of a video data item, and corresponds also to a set of index values (compressed image frame) in the compressed representation of the video data item. The input stage 312 may use the codebook(s) to determine the plurality of latent embedding vectors, and assemble the corresponding plurality of determined latent embedding vectors into a spatial tensor. This spatial tensor corresponds to a single subset of image frames of the video data item represented by the compressed representation. The tensor approximates the corresponding encoder output of the encoder network 111. Note that each of the input stages 312 employs the same codebook(s) as the output stage 112 of the compressor unit 11 and the input stage 122 of the reconstruction network 123.

Each of the adaptive systems 31, 32, 33 further includes a neural network (e.g. neural network 313) arranged to receive successively the spatial tensors output by the input stage of the corresponding adaptive system 31, 32, 33. The neural network 313 is defined by the values of a plurality of numerical parameters. The adaptive system is trained by iteratively adjusting the numerical parameters of the neural network 313, e.g. by a conventional training algorithm, so that the adaptive system 31, 32, 33 is trained perform the corresponding video processing task on the compressed representation received by the adaptive system 31, 32, 33. For example, if the video processing task for the adaptive system 31 is classification of a video data item, the parameters of the neural network 313 are trained so that the adaptive system 31 performs classification of the compressed representation of a video data item. This may be done by a standard classification training algorithm, as known for use in classifying video data items, except that the hyper-parameters are different. Since the neural networks receive spatial tensors, each neural networks may have a standard architecture known for performing the corresponding video processing task.

The neural network 313 may have different sizes and/or architectures for different ones of the adaptive systems 31, 32, 33, reflecting the different video processing task each performed. Optionally, the input stage 312 may be shared between the adaptive systems 31, 32, 33 and/or the neural networks of the adaptive systems 31, 32, 33 may share some components, e.g. a shared input layer of the neural networks.

For certain video processing tasks, it may be that the compressed representations stored in the second database 21 are insufficient to learn the video processing task, or that the learning efficiency would be improved by having more compressed representations to learn from. For this purpose, the system of FIG. 3 may include an augmentation network 35 which is configured to receive a compressed representation of a video data item from the second database 21 and to generate from it a modified compressed representation. The modified compressed representation depends upon a control input in the form of modification data 37 which specifies a modification operation. The augmentation network 35 is trained, upon receiving a compressed representation of a given video data item (the video data item being denoted X) and modification data 37 specifying a modification operation (denoted A), to generate an output which is the compressed representation which the compressor unit 11 would have generated upon receiving a video data item which is the given video data item X as modified by the modification operation A. In other words, the augmentation network 35, upon receiving a compressed representation of a given video data item X and modification data 37 specifying a modification operation A, generates a compressed representation of a modified video data item which is the given video data item X modified by the modification operation A.

The modification operation specified by the modification data 37 may comprise any one more of a crop operation, a brightness modification, a clipping operation, a rotation operation, a blurring operation, a flipping operation, or a color modification. For instance, A(X) can spatially crop the video data item X, based on bounding box (bb) defined by the modification data 37 describing the coordinates of the crop. The augmentation network 35 is typically implemented as a neural network which is relatively small, e.g. smaller than (i.e. defined by fewer adjustable parameters than) the neural network 313 of the adaptive systems 31, 32, 33.

Thus, when it is desired to increase the number of compressed representation which are available to train one of the adaptive systems 31, 32, 33, this may be done by selecting compressed representations from the second database 21, and applying a modification operation to each selected compressed representation based on corresponding modification data 37. The modification operation may optionally be different for different compressed representations. For example, it may be selected randomly.

FIG. 4 shows a system for training the augmentation network 35. This is done using a third database 40 of video data items (which may be the first database 20, before it is subsequently deleted as described above, or may alternatively be a different database of video data items). For each given one of the video data items of the third database 40, a corresponding compressed representation 41 is obtained using the compressor unit 11. The compressed representation 41 is input to the augmentation network 35. The augmentation network 35 may comprise a multi-layer perceptron (MLP) and/or a transformer, and the parameters of the MLP and/or transformer may initially be chosen to be default values or at random. The augmentation network 35 converts a compressed representation it receives to a modified compressed representation 42 based on (current) modification data 37. The modified compressed representation is received by the reconstruction network 12, which from it generates a corresponding first modified video data item 43. The given video data item from the third database 40 is also input to an augmentation unit 44 which also receives the current modification data 37. The augmentation unit 44 is configured to apply the modification operation specified by the modification data 37 to the given video data item, to generate a second modified video data item 45. Note that since the augmentation unit 44 operates on video data items, not compressed representations of video data items, it can be designed straightforwardly and need not be an adaptive component. A discrepancy is then calculated between the corresponding first and second modified video data items 43, 44. The process is repeated for different ones of the video data items in the third database 40 and/or for different realizations of the modification data 37, and a loss function is formed which sums the discrepancies for the corresponding different realizations of the first and second modified video data items and of the modification data. The augmentation network 35 is then trained iteratively, to minimize the loss function.

Denoting the operation performed by the compressor network 11 by c, the operation performed by the augmentation network 35 for given modification data 37 by a, and the operation performed by the reconstruction network 12 by c⁻¹, the compressed representation 41 produced by the compressor unit 11 of a given video data item X (e.g. a RGB video) in the third database 40 can be denoted by R=c(X). The augmentation network 35 transforms R(X) to a modified compressed representation 42 denoted R′=a(c(X)). When R′(X) is decompressed using the reconstruction network 12, it gives a first modified data item 43 which is c⁻¹(a(c(X)). The first modified data item 43 approximates a second modified video data item 44, denoted A(X), where A is the result of applying the modification operation specified by the modification data 37 to the video data item X. For example, in the case that the modification operation is a spatial cropping based on a bounding box bb, it is desired that A(X,bb)=c⁻¹(a(c(X,bb)).

During the training, the augmentation network 35 is iteratively modified to vary a (without changing the compressor unit 11 or the reconstruction network 12) so that, on average for video data items X from the third database, and over various choices for the modification data 37, the magnitude of a discrepancy c⁻¹(a(c(X))−A(X) is reduced. This is done by adjusting the parameters of the augmentation network to minimize a loss function obtained by summing c⁻¹(a(c(X))−A(X) for multiple choices of X and multiple choices for the modification data 37 (i.e. the function A). For example, in the case of modification operations which are cropping operations, training pairs may be created by randomly selecting pairs: a randomly-selected video data item Xand a corresponding randomly-selected bounding box bb. Using an l₁ loss function (which has been found to give good results), the loss function may then be the sum over the training pairs of:

$${‖ {c}^{- 1} ( a ( c ( X ) ) - A ( X ) ‖}_{{l}_{1}} .$$

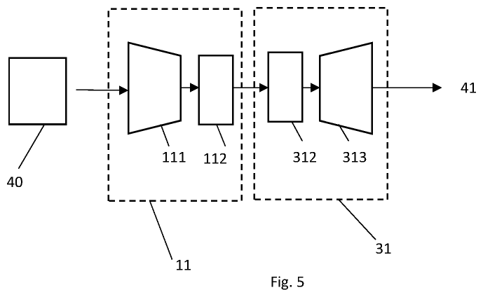

Once a given one of the adaptive systems 31, 32, 33 has been trained to perform the corresponding video processing task, it may be used in the manner shown in FIG. 5, as part of a system for processing a video data item 40. The video data item 40 is input to the trained compressor unit 11 to generate a corresponding compressed representation. The compressed representation is then input to the trained adaptive system (e.g. the adaptive system 31), to generate an output 41 which is the result of the video processing task corresponding to the adaptive system 31. For example, the output 41 may be data specifying a class to which the video data item 40 belongs, or whether the content of video data item 40 exhibits a certain property (e.g. contains repetitions meeting one or more criteria).

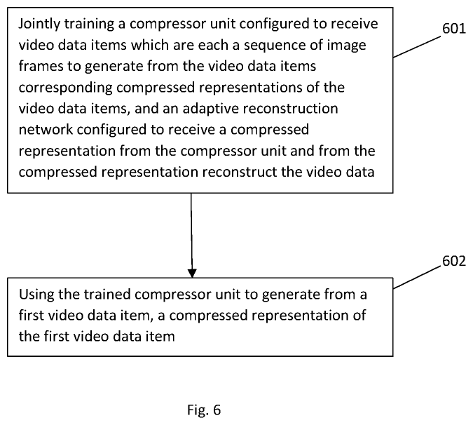

Turning to FIG. 6, a method is illustrated which can be performed by the systems described above. For example, the systems shown in FIGS. 1 and 2 may perform the method of FIG. 6. The method may be implemented as computer programs on one or more computers in one or more locations.

In step 601, a compressor unit and a reconstruction network are jointly trained, e.g. within the systems of FIG. 1. The compressor unit 11 is configured to receive video data items which are each a sequence of image frames, and to generate from the video data items corresponding compressed representations of the video data items. The adaptive reconstruction network 12 is configured to receive a compressed representation from the compressor unit 11 and from the compressed representation reconstruct the video data. The training process is an iterative process to minimize a loss function which is a sum, over a plurality of video data items 13 input to the compressor unit 11, of a measure of discrepancy between those video data items and corresponding reconstructed video data items 14 generated by the reconstruction network 12. In practice, the sum may be estimated by evaluating the measure of discrepancy for a plurality of video data items 13 sampled from a database of video data items.

In step 602, the trained compressor unit 11 is used, e.g. within the system shown in FIG. 2, to convert one or more first video data items 20 in a first database, to corresponding compressed representations 22 in a second database 21.

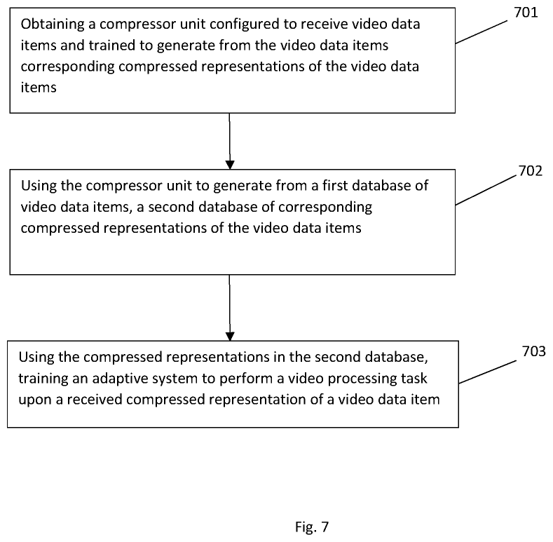

As described below with reference to FIG. 7, the compressed representations 22 may be used in an adaptive system learning process. However, this is not the only possible purpose of the database 21. For example, it may store the compressed representations 22 until a user desires to view a desired one or more of the corresponding video data items. At that time, the reconstruction network 12 can be used to reconstruct the desired one or more video data items. Thus, the method of FIG. 6 provides a convenient and efficient way of storing videos until it is desired to watch one or more of them.

Turning to FIG. 7, a method is illustrated which can be performed by the systems described above. For example, the systems shown in FIGS. 1, 2 and 3 may perform the method of FIG. 7. The method may be implemented as computer programs on one or more computers in one or more locations.

In step 701, a compressor unit is obtained which is configured to receive video data items and trained to generate from the video data items corresponding compressed representations of the video data items. Step 701 may be performed in the same way as step 601 of FIG. 6, e.g. using the system shown in FIG. 1. Alternatively, the step 701 may include receiving a trained compressor unit, e.g. over a communications network.

In step 702, the obtained compressor unit is used, e.g. by the system shown in FIG. 2, to generate from a first database of video data items, a second database of corresponding compressed representations of the video data items.

In step 703, the compressed representations in the second database are used, e.g. by the system shown in FIG. 3, to train one or more adaptive systems to perform corresponding video processing tasks upon a received compressed representation of a video data item.

Once trained, the adaptive system may be used, e.g. by the system shown in FIG. 5, to perform the video processing task, upon receiving a compressed representation of video item, such as a compressed representation generated by the compressor unit 11.

Results of experiments carried out on examples of the present disclosure are now presented.

A first experiment related to the quality of video compression and reconstruction performed in the compression-reconstruction system of FIG. 1. The videos employed were from the dataset Kinetics600 (Carrerira, J, et al, “A short note about kintetics-600”, arXiv:1808.01340 (2018)). The encoder and decoder networks used 3D CNNs with inverted ResNet blocks. The video data items were 32-frames long RBG videos in which each image frame was 256×256 pixels. These were compressed as described above with reference to FIGS. 1 and 2, to give compressed representations with a data size T_{T}T_{H}T_{L}T_{C} log₂ K. Various choices were made of these parameters to give different compression ratios (CR). The video data items were then reconstructed using the reconstruction network 12, and the reconstructed video data items were compared with the corresponding original video data items.

Table 1 compares three measures of reconstruction error: peak signal-to-noise ration (PSNR), structural similarity index measure (SSIM) and mean absolute error (MAE) for the present technique (last four lines) and using JPEG and MPEG encodings of the video data items, for various CR values. Good results are characterized by low MAE values and high PSNR and SSIM values. As shown in Table 1, the present technique generally outperformed JPEG and MPEG.

TABLE 1

| | Kinetics600 | | |
|---|---|---|---|
| | PSNR ↑ | SSIM ↑ | MAE ↓ |
| JPEG CR~30 | 36.4 | 94.1 | 0.013 |
| JPEG CR~90 | 25.1 | 70.2 | 0.045 |
| JPEG CR~180 | 22.5 | 63.1 | 0.057 |
| MPEG CR~30 | 33.2 | 89.6 | 0.034 |
| MPEG CR~90 | 38.7 | 82.4 | 0.026 |
| MPEG CR~180 | 23.7 | 67.3 | 0.054 |
| CR~30 | 38.6 | 97.6 | 0.008 |
| CR~236 | 30.8 | 89.8 | 0.019 |
| CR~384 | 30.0 | 88.4 | 0.019 |
| CR~768 | 29.0 | 85.4 | 0.022 |

A second experiment investigated training an adaptive system 31 as shown in the manner shown in FIG. 3, to perform a classification task in the system of FIG. 4, using compression units 11 having various corresponding CRs as in the first experiment. The neural network 313 of the adaptive system 31 had the S3D architecture described in Xie, S., at al., “Rethinking spatiotemporal feature learning for video understanding”, arXiv preprint arXiv:1712.04851. Following the training using a training set of video data items, the accuracy of the classification was measured using a test set of video data items. “Top-1” accuracy was measured (i.e. the proportion of input video items for which the classification provided by the adaptive system 31 in the system of FIG. 5 was exactly correct). In the second experiment, the video data items of the test set are taken from the Kinetic600 database. Table 2 shows the case that the training set of video data items are taken from the Kinetic600 database, and the case that the training set of video data items are taken from a database referred to as “Walking Tours”. As can be seen, a 30× compression ratio led to only a small (about 1%) drop in performance. Even a 256× or 475× compression ratio led to only a 5% difference in performance, despite the enormous reduction of the size of the training set which such a compression ratio implies. Furthermore, the training time is significantly reduced compared to using uncompressed video data items. For example, using a compression ratio of 256×, it was found that a forward pass to modify the parameters of the adaptive network took only half the processing time as one using uncompressed video data items. A combination of these two factors meant that it was possible, at reasonable processing cost, to learn video processing tasks on video data items which were multiple minutes long, or even hour long video data items.

TABLE 2
Evaluated on K600

| | |
|---|---|
| Trained on K600 | Trained on WalkingTours |

| CR | Top-1 ↑ | CR | Top-1 ↑ |
|---|---|---|---|
| CR~1 | 73.1 | CR~1 | 73.1 |
| CR~30 | 72.2 | CR~30 | 71.3 |
| CR~475 | 68.2 | CR~256 | 68.4 |

Further experiments were made relating to the augmentation network 35 as described above in relation to FIGS. 3 and 4, using modification operations which were cropping operations or flipping operations, in the case of video data items having a size in which each image frame was 256×256 pixels. The augmentation network 35 was implemented as a multi-layer perceptron (with three hidden layers) and a two-layer transformer. The transformer produced an output conditioned on the modification data 37. It was found visually that following the training of the augmentation network 35, the first modified video data items 43 closely resembled the second modified video data items 45 according to visual inspection. This observation was quantitatively confirmed by SSIM scores (0.96) between the first modified video data items 43 and the second modified video data items 45. When an adaptive learning system was trained to perform a video processing task using modified data items, in the system shown in FIG. 3, incorporating the augmented videos improved the performance of the video processing task significantly.

There follows a discussion of exemplary video processing tasks which the adaptive system can be trained to perform using the disclosed methods. Specifically, the trained compressor unit may be used to generate a compressed representation of a received video (i.e. a video data item, such as a newly generated video captured by a video camera) and the trained adaptive system may be used to perform the video processing task on the compressed representation. Thus, the compressor unit and trained adaptive system may be used as a single video processing system. In the case that the adaptive system includes an input stage for decoding compressed representations based on the codebook(s), this input stage, and the portion of the compressor unit which encodes the output of the encoder network using the codebook(s), may be omitted.

A first possibility is for the video processing task to recognize the content of a received video. This may be treated as a classification task, that is to generate, based on a compressed representation corresponding to a video data item, one or more labels indicative of content of the video data item. In one example, the labels may indicate whether the video depicts (shows) an object or animal in one or a plurality of predetermined categories (e.g. the category “dogs”, or the category “humans”; categories may even be defined relating to a specific human, such that the label(s) indicate whether the specific human is depicted in the video), or a real-world event in one of a plurality of determined categories (e.g. a car crash). Thus, using the disclosed method, a video processing system is produced which is able to generate labels of this kind. One use of the video processing system would be to scan a database of videos to generate metadata based on the labels and describing the content of the videos. Another use of the video processing system would be to scan a database of videos to identify videos in which an object or animal in one of the categories appears, or to identify problematic videos (e.g. ones with pornographic content) for possible removal from the database.

The process of training the adaptive system may for example be performed in a supervised manner, based on labels (e.g. stored in the second database) associated with the compressed representations in the second database, and indicating the content of the corresponding video data items stored in the first database. The labels may be supplied to the training system together with the video data items which are stored in the first training database. The training algorithm may be any known algorithm used in the field of supervised learning, e.g. to minimize a loss function which characterizes discrepancies, when the adaptive system receives one of the compressed representations in the second database, between labels it generates and the corresponding labels associated with the received compressed representation.

Optionally, the labels which the adaptive system is trained to generate for a given received data item may relate not to the video data item as a whole, but to specific portions of the video data items, such as (proper) subsets of the image frames of the video data item (e.g. such that the label indicates which of the frames depicts an object or animal of a given category and/or an event of a given category). In this case, the labels associated with corresponding compressed representations in the second database also relate to subsets of the image frames of the video data items in the first database, e.g. indicating that those (and only those) image frames depict objects, animals or events in one of the defined categories.

Furthermore, the specific portions of the video data items for which the adaptive system is trained to generate labels, may be areas (i.e. groups of pixels) in image frames of a video data item corresponding to the compressed representation. For example, the labels may indicate that a specific portion (sub-area) of one or more specific image frames depicts an object or animal in a given category or an event in a given category. Thus, thus label generates a segmentation within image frames of a received video item. In this case, the labels associated with the compressed representations in the second database relate to specific portions of image frames of the video data items in the first database, e.g. indicating that those (and only those) specific portions of the image frames of the video data items depict objects, animals or events in one of the defined categories

Although the explanation above is based on the supervised learning, in an alternative the training of the adaptive system may be based on self-supervised learning based on the compressed representations in the second database.

An alternative video processing task which the adaptive system can be trained to perform is to generate data indicating whether a certain image frame (an “index image frame”), or another image frame meeting a similarity criterion with respect to the index image frame, is present in at least a portion of a video data item.

For example, the index image frame may be an image frame corresponding to a compressed image frame which the adaptive system receives at a current time (a compressed image frame which the adaptive system receives as one of the sequence of compressed image frames in the compressed representation of a video data item), and the video processing task may be to generate data indicating whether an identical image frame (or one meeting a similarity criterion with respect to the index image frame) was present in an earlier portion of the video data item. To put this more simply, the video processing task is to receive sequentially the compressed image frames of the compressed representation of a video frame, and to generate data which indicates whether any of these compressed image frames corresponds to an image frame which is identical to, or similar to, an image frame which is earlier in the video data item. For example, the video processing task may be to identify that an object or animal in a certain category is depicted at multiple times in a video. For example, if the video is a surveillance video of a geographic area, the task may identify that an individual who enters the area has been there before (i.e. an image of the same individual is present in an earlier part of the video).

In another example, the adaptive system may receive both the compressed representation of a video data item (e.g. as successive compressed image frames) and the index image frame which may be an image of a specific person (or other animal or object). The video processing task may be to recognize whether that person is depicted in any image frames of the video data item.

Another possible example of a video processing task is to reconstruct a video data item from a compressed representation of the video data item. Although the reconstruction network may already exist to perform this task, in some cases the reconstruction network may no longer be available, or it may be unsuitable for a particular application (e.g. it is too large or it is not sufficiently accurate).

In a further possibility, the video processing task is an agent control task. In this case, the video comprises observations of successive states of a real-world environment and the output of the adaptive system which is trained using the second database of compressed representations defines physical actions to be performed by the agent in response to the observations to perform a task in the environment. The agent can be a mechanical agent in the real-world environment, e.g. a real-world robot interacting with the environment to accomplish a manipulation task, or an autonomous or semi-autonomous land or air or water vehicle navigating through the environment to perform a navigation task. The agent may move in the real-world environment, e.g. translationally (i.e. changing its location in the environment) and/or altering its configuration. The video data items in the first database may comprise videos of the task being correctly performed. The actions may comprise control inputs to control a physical behavior of the mechanical agent e.g. in the case of a robot, torques for the joints of the robot or higher-level control commands.

The subject matter described in this specification can be implemented in particular embodiments so as to realize one or more of the following advantages. First, using the method, the computational cost of training the adaptive system to perform the video processing task can be much reduced, compared to training an adaptive system to perform the video processing task based on raw video data items. This is partly because an adaptive system which operates based on compressed representations typically needs fewer variable parameters than an adaptive system which processes complete video data items, so fewer update values are calculated in each iteration. Furthermore, convergence may be faster, e.g. because a cost function minimized during the training tends to have steeper gradients with respect to variations of any single variable parameter of the adaptive system. Also, as compressed representations are much smaller than video data items, the costs of computational operations during the training process are smaller than they would be using the raw data items. The computational operations in which savings may be made by using compressed representations in place of raw video data items include: reading compressed representations from the database where they are stored; transmitting them to the input of the adaptive system (especially if the training process is performed using a distributed system); and processing them using the semi-trained adaptive system. Note that some of these computational operations have a computational costs which increases dramatically, e.g. in a non-linear way, if the size of the dataset they have to be performed on rises above a certain threshold (e.g. such that the dataset is too large to store all at once in a certain cache memory of a computer system which implements the training process).

Secondly, the size of the databases used to store the training data can be enormously reduced, since during the training of the adaptive system the first database is no longer required, and the compressed representations stored in the second database are far smaller. Optionally, as each compressed representation in the second database is generated, the corresponding video data item in the first database is discarded, e.g. deleted or marked as available for overwriting. Thus, if the process of populating the first database with video data items is concurrent with the process of populating the second database with compressed representations, the maximum size of the first database may remain within an acceptable limit.

Together, these factors mean that using the presently disclosed methods an adaptive system may be trained, within the capacities of present day computer systems, to perform video processing tasks on videos which are 100 MBs or larger (e.g. many minutes or even many hours of video). Thus, it is possible to identify regularities in videos on these time-scales, e.g. to identify that a certain individual has entered a geographical area surveilled by a surveillance video twice, at times two hours apart, or to notice that a person who deposits an object in the geographical area is different from the person who collects it an hour later, or to identify that an operation which is normally performed at regular intervals in a video has, exceptionally, taken place later or earlier than expected.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them. The computer storage medium is not, however, a propagated signal.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows can be performed by and apparatus can also be implemented as a graphics processing unit (GPU).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method of training an adaptive system to perform a video processing task, the method comprising:
obtaining a compressor unit configured to receive video data items which are each a sequence of image frames, and trained to generate from the video data items corresponding compressed representations of the video data items, each compressed representation having lower data size than the corresponding video data item;
using the compressor unit to generate from a first database of video data items, a second database of corresponding compressed representations of the video data items; and
using the compressed representations in the second database, training an adaptive system to perform the video processing task upon a received compressed representation of a video data item.

2. The computer-implemented method of claim 1 in which the compressor unit comprises a three-dimensional convolution unit, which at successive times receives a corresponding plurality of the image frames in the video data item, and performs a convolution collectively on the plurality of image frames.

3. The computer-implemented method of claim 2 in which the compressed representation of each video data item comprises, for each image frame of the video data item, a respective compressed image frame, the compressed image frame being generated based on a result of applying the three-dimensional convolution unit to a plurality of image frames of the video data item comprising the image frame.

4. The computer-implemented method of claim 1 in which the compressor unit is configured to generate the compressed representation of a received video data item by:
successively inputting a plurality of subsets of the image frames of the video data item into an encoder network to generate, for each subset of the image frames of the video data item, a corresponding encoder output that comprises a respective array of latent variables; and
generating the compressed representation of the video data item by, for each of the latent variables in each array of latent variables, determining, in a set of latent embedding vectors, a latent embedding vector that is nearest to the latent variable, and generating a corresponding portion of the compressed representation of the determined nearest latent embedding vector.

5. The computer-implemented method of claim 4 in which the compressed representation is a set of index values associated with the determined nearest latent embedding vectors for the corresponding latent variables of the encoder output.

6. The computer-implemented method of claim 4 in which the adaptive system includes an input stage configured to converting portions of the compressed representations into respective ones of the set of latent embedding vectors.

7. The computer-implemented method of claim 4 when dependent upon claim 2, in which the encoder network includes the three-dimensional convolution unit.

8. The computer-implemented method of claim 4 in which the compressor unit is obtained by training the compressor unit jointly with an adaptive reconstruction network configured to receive a said compressed representation and from the compressed representation reconstruct the video data.

9. The computer-implemented method of claim 8, in which the adaptive reconstruction network comprises an input stage configured to convert portions of the compressed representations into respective ones of the set of latent embedding vectors.

10. The computer-implemented method of claim 9 in which training the compressor unit comprises iteratively varying the latent embedding vectors.

11. The computer-implemented method of claim 8, further comprising training an adaptive augmentation network to receive compressed representations generated by the compressor unit based on corresponding video data items, and from the compressed representations generate modified compressed representations,
the training of the adaptive augmentation network being based on a reconstruction loss function comprising a discrepancy term indicative of a discrepancy, for each of a plurality of compressed representations, between an output of the reconstruction network upon receiving the corresponding modified compressed representation and a modified video data item which is obtained by performing a modification operation to the corresponding video data item.

12. The computer-implemented method of claim 11 further comprising, for each of one or more of the compressed representations in the second database, using the augmentation network to generate from the compressed representations, corresponding modified compressed representations, and adding the modified compressed representations to the second database,
said training the adaptive system to perform the video processing task being performed using the modified compressed representations.

13. The computer-implemented method of claim 12 in which the augmentation network is configured to receive modification data indicative of the modification operation, and, for each of the one or more of the compressed representations in the second database, to generate a plurality of corresponding modified compressed representations successively by different respective modification operations selected according to successive realizations of the modification data.

14. The computer-implemented method of claim 11 in which the modification operation comprises one or more items selected from the group consisting of: a crop operation; a brightness modification; a clipping operation; a rotation operation; a flipping operation; a blurring operation; and a color modification.

15. The computer-implemented method of claim 11 in which the modification operation is selected by an adaptive unit which is trained jointly with the augmentation network to generate a modification operation which maximizes the discrepancy term.

16. The computer-implemented method of claim 1 in which the video processing task is to generate, based on a compressed representation corresponding to a video data item, one or more labels indicative of content of the video data item.

17. A computer-implemented method of claim 16 in which the labels comprise labels which are associated with one or more image frames which are a sub-set of the image frames of the video data item, and/or labels which are associated with a sub-set of the pixels in one or more of the image frames of the video data item.

18. The method of claim 16 in which said training the adaptive system is performed by supervised learning using labels associated with corresponding ones of the compressed representations in the second database, or by self-supervised learning.

19. The method of claim 1 in which the video processing task is to receive an index image frame, and generate output data indicative of whether the index image frame, or another image frame meeting a similarity criterion with respect to the index image frame, is present in at least a portion of a video data item.

20. The method of claim 1 in which the video processing task is to reconstruct a video data item from a compressed representation of the video data item.

21. The method of claim 1 in which the video processing task is to train an agent to perform a task in an environment, the video data items of the first database depicting instances of the task being performed.

22. A computer-implemented method of generating a compressed representation of a first video data item, the method comprising:
jointly training a compressor unit configured to receive video data items which are each a sequence of image frames to generate from the video data items corresponding compressed representations of the video data items, and an adaptive reconstruction network configured to receive a compressed representation from the compressor unit and from the compressed representation reconstruct the corresponding video data item; and
using the trained compressor unit to generate from the first video data item, a compressed representation of the first video data item.

23. The computer-implemented method of claim 22 in which the compressor unit is configured to generate the compressed representation of a received video data item by:
successively inputting a plurality of subsets of the image frames of the video data item into an encoder network to generate, for each subset of the image frames of the video data item, a corresponding encoder output that comprises a respective array of latent variables; and
generating the compressed representation of the video data item by, for each of the latent variables in each array of latent variables, determining, in a set of latent embedding vectors, a latent embedding vector that is nearest to the latent variable, and generating a corresponding portion of the compressed representation as an index value of the determined nearest latent embedding vector;
the adaptive reconstruction network comprising an input stage configured to convert the index values of the compressed representations into respective ones of the set of latent embedding vectors.

24. The computer-implemented method of claim 23 in which training the compressor unit comprises iteratively varying the latent embedding vectors.

25. A system comprising one or more computers and one or more storage devices storing instructions that when executed by the one or more computers cause the one or more computers to perform operations for training an adaptive system to perform a video processing task, the operations comprising:
obtaining a compressor unit configured to receive video data items which are each a sequence of image frames, and trained to generate from the video data items corresponding compressed representations of the video data items, each compressed representation having lower data size than the corresponding video data item;
using the compressor unit to generate from a first database of video data items, a second database of corresponding compressed representations of the video data items; and
using the compressed representations in the second database, training an adaptive system to perform the video processing task upon a received compressed representation of a video data item.

26. (canceled)
